(19) United States
(12) Patent Application Publication
(10) Pub. No.: US 2025/0129296 A1
(43) Pub. Date: Apr. 24, 2025

(54) HIGH DIESEL SELECTIVITY DURING MANUFACTURE OF RENEWABLE DIESEL

(71) Applicant: CHEVRON U.S.A. INC., San Ramon, CA (US)

(72) Inventors: Trevor FISHER, Cedar Falls, IA (US); Ramin ABHARI, Tulsa, OK (US); Fredd PATTERSON, Ankeny, IA (US)

(21) Appl. No.: 18/926,143

(22) Filed: Oct. 24, 2024

Related U.S. Application Data
(60) Provisional application No. 63/592,710, filed on Oct. 24, 2023.

(51) Int. Cl. C10G 3/00

(52) U.S. Cl. CPC C10G 3/50; C10G 2300/1014; C10G 2300/1018; C10G 2300/304; C10G 2300/4006; C10G 2400/04

(57) ABSTRACT

A method for selective renewable diesel production by hydrodeoxygenation of a lipid to form a product that is further processed with stripping, hydroisomerization and fractionation to produce a renewable diesel.

### CROSS REFERENCE TO RELATED APPLICATIONS

This application is related to and claims the benefit of priority of U.S. Provisional Patent Appl. Ser. No. 63/592,710, filed on Oct. 24, 2023, the disclosure of which is herein incorporated in its entirety.

### FIELD OF THE INVENTION

The present invention relates to manufacture of biofuels. More particularly, the invention relates to biomass-based diesel fuels such as renewable diesel produced from lipid feedstock, and methods to manufacture the same.

### BACKGROUND OF THE INVENTION

Hydroprocessing of lipids for production of Renewable Diesel (RD) fuel has been described in the prior art such as U.S. Pat. Nos. 8,026,401 and 7,968,757. As described in these and other references, RD is produced in two conversion steps. In the first step, a hydrodeoxygenation (HDO) reactor system converts the lipid fatty acid molecules to hydrocarbons comprising n-paraffins in the diesel boiling range. With typical lipid feeds comprising mainly fatty acid glycerides, propane is a coproduct. Water, CO, and CO₂ are the main byproducts of HDO. Whereas water is the direct product of the HDO reaction (i.e. product of the removal of oxygen heteroatoms with hydrogen), CO and CO₂ are the products of decarbonylation and decarboxylation side reactions respectively (referred to here as “DCO” reactions for short) side reactions. An “HDO Selectivity” parameter may be used to quantify the relative tendency of the deoxygenation reactions to proceed via the direct hydrodeoxygenation pathway compared to overall deoxygenation involving DCO side reactions.

HDO systems typically include fixed-bed reactors operating with partial recycle of hydrocarbon product. The hydrocarbon recycle stream acts as a solvent for the lipid feed. The solvent dilution provides a number of benefits to HDO performance. These include control of heat release associated with the exothermic reaction, improving hydrogen solubility, and minimizing undesirable side reactions.

The lipid feedstocks for HDO include various animal fats, vegetable/plant oils, and spent cooking oils/greases from food processing operations. Depending on the quality of the feedstock, pretreatment steps are often included in the RD process to remove contaminants. The lipid fed to the HDO reactor typically has less than 10 wppm phosphorus and less than 10 wppm total of the main metal contaminants, including iron, sodium, potassium, calcium, and magnesium. Nitrogen compounds tend to be present in many lipid streams, especially those comprising animal fats, with levels of nitrogen to the HDO reactor in the 50-500 ppm range.

To convert the C16+n-paraffin “wax” (i.e. n-hexadecane and longer-chain n-paraffins) and improve cloud point and other low temperature flow properties, the straight-chain n-paraffins in the HDO product are converted to mainly methyl-branched isoparaffins in the second step. This second step is referred to as “catalytic dewaxing” or “hydroisomerization” (HI). Ideally, the HI reaction retains the hydrocarbon product in diesel boiling range while converting the n-paraffins to iso-paraffins of the same carbon number. However, to achieve the desired degree of “wax” conversion, hydrocracking side-reactions occur during HI.

These HI side reactions produce mostly naphtha, a C4-C9 hydrocarbon fraction in the gasoline boiling range. Due to high concentration of straight-chain light paraffins such as n-heptane (with “octane rating” of 0 in the anti-knock index), naphtha's use as a motor gasoline blend stock is limited.

On the other hand, RD is considered a premium clean burning diesel fuel. With a cetane number above 80, RD is a high performance fuel for compression ignition engines. The absence of aromatic hydrocarbons also provides RD with desirable emission properties, including a significantly lower particulate matter emissions.

Depending on the lipid feedstock, RD typically has a carbon intensity in the range of 20-40 g CO2e/MJ. Carbon intensity is a measure of life cycle greenhouse gas emissions expressed as grams of CO2 equivalent per megajoule of combustion energy provided by the fuel. The cited RD carbon intensity value is 60-80% lower than what is reported for petroleum-based Ultra Low Sulfur Diesel fuel. As such, RD production has grown rapidly over the past decade as a response to climate change.

Given the advantaged fuel properties of RD compared to naphtha, a high selectivity for RD relative to naphtha is sought. It is towards that unmet need that the present invention is directed.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

The prior art teaches that RD selectivity is dictated by HI catalyst and operating conditions. It has surprisingly been discovered that other variables, including HDO reactor performance parameters, also contribute to achieving high selectivity towards RD.

In an aspect of the present invention, a lipid feedstock is subjected to deoxygenation under HDO conditions wherein the HDO selectivity is less than 89%. The paraffinic HDO product, subsequently stripped of dissolved HDO gas phase byproducts such as water, H2S, NH3, CO, and CO2, has a nitrogen content less than 0.85 wppm, an iso/normal ratio of at least 0.06, and a total acid number less than 0.10 mg KOH/g. The stripped HDO product is subject to hydroisomerization (HI) at an HI reactor Weighted Average Bed Temperature that is preferably less than 616 F, to provide a reactor effluent comprising a renewable diesel (RD) fraction. The RD has a cloud point of −11 C or higher and an octadecane content of 6.3 wt % or higher.

The present technology achieves a diesel selectivity (volume of RD as a percent of total liquid fuels) of at least 95%.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts an embodiment of the high diesel selectivity method of renewable diesel production according to the present disclosure.

### DETAILED DESCRIPTION OF THE INVENTION

The apparatuses and methods disclosed in this document are described in detail by way of examples and with reference to the FIGURES. Unless otherwise specified, like numbers in the FIGURES indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

### Definitions

As used herein, “about” will mean up to plus or minus 10% of the particular term. The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “alkyl” groups include straight chain and branched alkyl groups. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. It will be understood that the phrase “Cᵢ-Cⱼ alkyl,” such as C₁-C₄ alkyl, means an alkyl group with a carbon number falling in the range from i to j.

The term “aromatics” as used herein is synonymous with “aromates” and means both cyclic aromatic hydrocarbons that do not contain heteroatoms as well as heterocyclic aromatic compounds. The term includes monocyclic, bicyclic and polycyclic ring systems. The term also includes aromatic species with alkyl groups and cycloalkyl groups. Thus, aromatics include, but are not limited to, benzene, azulene, heptalene, phenylbenzene, indacene, fluorene, phenanthrene, triphenylene, pyrene, naphthacene, chrysene, anthracene, indene, indane, pentalene, and naphthalene, as well as alkyl and cycloalkyl substituted variants of these compounds. In some embodiments, aromatic species contains 6-14 carbons, and in others from 6 to 12 or even 6-10 carbon atoms in the ring portions of the groups. The phrase includes groups containing fused rings, such as fused aromatic-aliphatic ring systems (e.g., indane, tetrahydronaphthene, and the like).

“Oxygenates” or an “oxygenated hydrocarbon” as used herein means carbon-containing compounds containing at least one covalent bond to oxygen. Examples of functional groups encompassed by the term include, but are not limited to, carboxylic acids/esters, carboxylates, acid anhydrides, aldehydes, esters, ethers, ketones, and alcohols. Oxygenates may also be oxygen containing variants of aromatics, cycloparaffins, and paraffins as described herein. Fatty acids/glycerides are naturally occurring carboxylic acids/esters that define lipids.

A “lipid” as used herein refers to fats, oils, and greases. Lipids comprise of saturated and unsaturated fatty acids in the C₈-C₂₄ range, wherein the fatty acids can be in the form of esters of glycerin (i.e. as mono-, di-, and triglycerides), or as free fatty acids (FFA).

The term “paraffins” as used herein means non-cyclic, branched or unbranched alkanes. An unbranched paraffin is an n-paraffin; a branched paraffin is an iso-paraffin. “Cycloparaffins” are cyclic, branched or unbranched alkanes.

The term “paraffinic” as used herein means both paraffins and cycloparaffins as defined above as well as predominantly hydrocarbon chains possessing regions that are alkane, either branched or unbranched.

The term “olefin” as used herein means non-cyclic, branched or unbranched alkenes. The term “olefinic” as used herein means both mono- or di-unsated (i.e., one or two double bonds) hydrocarbons, either cyclic, branched or unbranched.

Hydroprocessing as used herein describes the various types of catalytic reactions that occur in the presence of hydrogen without limitation. Examples of the most common hydroprocessing reactions include, but are not limited to, hydrogenation, hydrodesulfurization (HDS), hydrodenitrogenation (HDN), hydrotreating (HT), hydrocracking (HC), aromatic saturation or hydrodearomatization (HDA), hydrodeoxygenation (HDO), decarboxylation (DCO), hydroisomerization (HI), hydrodewaxing (HDW), hydrodemetallization (HDM), decarbonylation, methanation, and reforming. Depending upon the type of catalyst, reactor configuration, reactor conditions, and feedstock composition, multiple reactions can take place that range from purely thermal (i.e., do not require catalyst) to catalytic. In the case of describing the main function of a particular hydroprocessing unit, for example an HDO reaction system, it is understood that the HDO reaction is merely one of the predominant reactions that are taking place and that other reactions may also take place.

Decarboxylation (DCO) is understood to mean hydroprocessing of an organic molecule such that a carboxyl group is removed from the organic molecule to produce CO₂, as well as decarbonylation which results in the formation of CO.

Pyrolysis is understood to mean thermochemical decomposition of carbonaceous material with little to no diatomic oxygen or diatomic hydrogen present during the thermochemical reaction. The product fractions obtained by pyrolysis are referred to as pyrolyzates.

Hydrotreating (HT) involves the removal of elements from groups IIIa, Va, VIa, and/or VIIa of the Periodic Table from organic compounds. Hydrotreating may also include hydrodemetallization (HDM) reactions. Hydrotreating thus involves removal of heteroatoms such as oxygen, nitrogen, sulfur, and combinations of any two more thereof through hydroprocessing. For example, hydrodeoxygenation (HDO) is understood to mean removal of oxygen by a catalytic hydroprocessing reaction to produce water as a by-product; similarly, hydrodesulfurization (HDS) and hydrodenitrogenation (HDN) describe the respective removal of the indicated elements through hydroprocessing.

Hydrogenation involves the addition of hydrogen to an organic molecule without breaking the molecule into subunits. Addition of hydrogen to a carbon-carbon or carbon-oxygen double bond to produce single bonds are two nonlimiting examples of hydrogenation. Partial hydrogenation and selective hydrogenation are terms used to refer to hydrogenation reactions that result in partial saturation of an unsaturated feedstock. For example, vegetable oils with a high percentage of polyunsaturated fatty acids (e.g., linoleic acid) may undergo partial hydrogenation to provide a hydroprocessed product wherein the polyunsaturated fatty acids are converted to mono-unsaturated fatty acids (e.g., oleic acid) without increasing the percentage of undesired saturated fatty acids (e.g., stearic acid). While hydrogenation is distinct from hydrotreatment, hydroisomerization, and hydrocracking, hydrogenation may occur amidst these other reactions.

Hydrocracking (HC) is understood to mean the breaking of a molecule's carbon-carbon bond to form at least two molecules in the presence of hydrogen. Such reactions typically undergo subsequent hydrogenation of the resulting double bond.

Hydroisomerization (HI) is defined as the skeletal rearrangement of carbon-carbon bonds in the presence of hydrogen to form an isomer. Hydrocracking is a competing reaction for most HI catalytic reactions and it is understood that the HC reaction pathway, as a minor reaction, is included in the use of the term HI. Hydrodewaxing (HDW) is a specific form of hydrocracking and hydroisomerization designed to improve the low temperature characteristics of a hydrocarbon fluid.

It will be understood that if a composition is stated to include “Cᵢ-Cⱼ hydrocarbons,” such as C₇-C₁₂ n-paraffins, this means the composition includes one or more paraffins with a carbon number falling in the range from i to j.

A “middle distillate” in general refers to a petroleum fraction in the range of about 200° F. (93° C.) to about 800° F. (427° C.). This includes kerosene (about 200-520° F.), diesel and light gasoil (about 400 to 650° F.), and heavy gasoil (about 610-800° F.).

“HDO Selectivity” is the ratio of oxygen removal by HDO pathway to total oxygen removal by both the HDO and DCO pathways. During hydroprocessing of lipids, the HDO pathway retain the fatty acid carbon number (whereby C₁₈ fatty acids are converted to a C₁₈ paraffin). The DCO pathway on the other hand achieves deoxygenation by removal of carbon as CO and CO₂ thus subtracting a carbon from the fatty acid chains (whereby a C₁₈ fatty acid is converted to C₁₇ hydrocarbons). HDO Selectivity is thus calculated as % C₁₈/(% C₁₇+% C₁₈) where % C₁₈ and % C₁₇ refer to wt % of n-octadecane and wt % n-heptadecane respectively as measured by GC. Since the GC response factors for these paraffins are about the same, GC peak area % values may be used for HDO selectivity calculations.

“Diesel Selectivity,” “Renewable Diesel Selectivity,” or “RD Selectivity” are used interchangeably here and defined as vol RD/(vol naphtha+vol RD) wherein vol RD and vol naphtha refer to the relative volumetric production rates of renewable diesel and naphtha, respectively, via hydroisomerization of the HDO product.

The HDO product fed to the HI reactor for hydroisomerization may be characterized by a Total Acid Number or TAN. TAN is a measurement of acidity that is determined by the amount of potassium hydroxide (KOH) in milligrams that is needed to neutralize the acids in one gram of oil. TAN may be measured by a few different titration methods including ASTM D974 and D3242.

The Cloud Point of a diesel fuel is the temperature below which wax crystals form to give the fuel a cloudy appearance. Cloud point is measured using standard test methods ASTM D2500, D5722, or alternatively IP 219.

Iso/normal ratio refers to the ratio of isoparaffins to normal paraffins in a paraffinic hydrocarbon composition. Iso/normal ratio is measured by dividing the total concentration of isoparaffins to the total concentration of n-paraffins in the hydrocarbon composition. Iso/normal ratio may be measured by Gas Chromatography, as area % values for n-paraffin and iso-paraffins may be used to calculate the ratio.

Nitrogen content here refers to the residual nitrogen heteroatom present in a treated hydrocarbon composition, such as the HDO product. The nitrogen value is measured via standard test method ASTM D4629 or equivalent.

A liquid hourly space velocity (LHSV) refers to the volumetric flow rate of the liquid feed to a fixed bed reactor divided by the volume of the catalyst therein (in the same units of volume), expressed in units of h⁻¹ (inverse hours).

A weighted average bed temperature (WABT) is commonly used in fixed bed, adiabatic reactors to express the “average” temperature of the reactor which accounts for the nonlinear temperature profile between the inlet and outlet of the reactor.

$$WABT = \text{?} ( WAB \text{?} ) ( W \text{?} )$$

$$WAB \text{?} = \frac{\text{?} + 2 \text{?}}{3}$$

$$\text{?} \text{indicates text missing or illegible when filed}$$

In the equation above, Tᵢⁱⁿ and Tᵢ^{out} refer to the temperature at the inlet and outlet, respectively, of catalyst bed i. As shown, the WABT of a reactor system with N different catalyst beds may be calculated using the WABT of each bed (WABTᵢ) and the weight of catalyst in each bed (Wcᵢ).

### Description of the Process

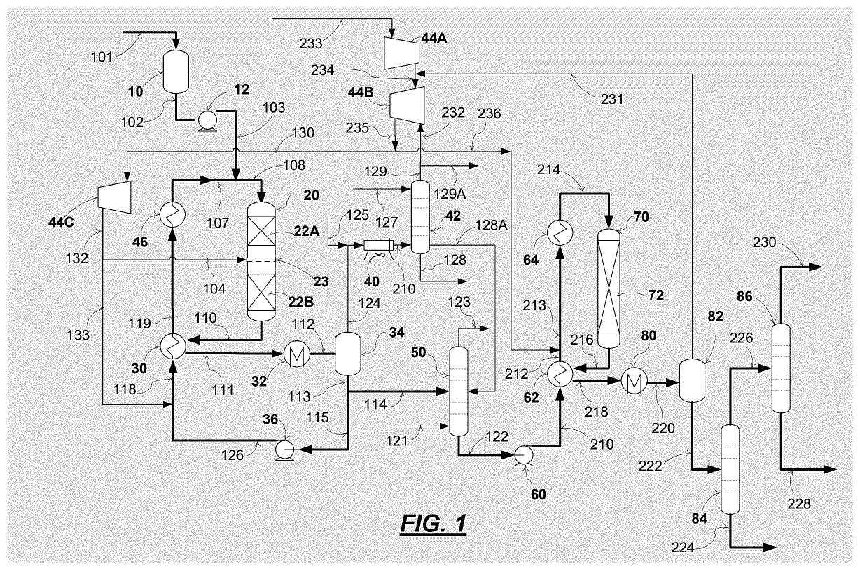

An embodiment of a high diesel selectivity method for RD production according to the present invention is presented in FIG. 1. Referring to FIG. 1, a lipid feedstock 101 is directed to a surge drum 10. The feedstock 101 is preferably subjected to a pretreatment step that has removed most contaminants, reducing the phosphorus concentration to less than 5 wppm, iron to less than 2 wppm, and all other metals in Groups I and II of the periodic table to a value of less than 5 wppm total. Methods for achieving such pretreatment performance have been disclosed in prior art, including U.S. Pat. Nos. 9,404,064, 11,118,133, and 11,459,523.

In embodiments, the lipid feedstock 101 comprises low value animal fats such as Bleachable Fancy Tallow, Choice White Grease (CWG), Technical Tallow (TT), and Tallow Fatty Acid Distillate (TFAD). In embodiments, the lipid feedstock further comprises plant-based oils such as Soybean Oil (SBO) and Palm Sludge Oil (PSO). In embodiments, the lipid feedstock further comprises greases from industrial food processing and restaurant operations such as Used Cooking Oil (UCO) and Yellow Grease (YG). UCO may be classified into low chlorine UCO and high chlorine UCO. Here, chlorine refers to the organochlorine contaminants and adulterant present in the UCO measured by test methods such as microcoulometry. Low-chlorine UCO has chlorine levels below 10 ppm, typically between 2 and 8 ppm, whereas high-chlorine UCO has chlorine concentrations above 10 ppm, typically between 12 and 50 ppm. In embodiments, the lipid feedstock may further comprise the residue from distillation of biodiesel or biodiesel bottoms, as described in U.S. Pat. No. 11,078,427. Biodiesel bottoms comprises undistilled biodiesel (methyl/ethyl fatty acid esters), as well as monoglycerides and at least 40% sterols and sterol esters.

Returning again to FIG. 1, a surge drum lipid feedstock 102 is transferred to HDO reactor 20 via a high-pressure pump 12. The pressurized lipid feedstock 103 is combined with a pressurized hydrogen-containing hot solvent 107 to provide a diluted heated lipid feed 108 to the HDO reactor 20. The diluted heated lipid feed 108 enters the HDO reactor 20 at a temperature between 460 F and 680 F, preferably between 500 F and 650 F. The inlet temperature is selected to maintain the WABT of the HDO reactor between about 550 and 700 F, preferably between 600 and 650 F.

In embodiments, the HDO reactor 20 is a fixed-bed reactor packed with a catalyst comprising a metal from Group VIb of the periodic table (IUPAC Group 4), and optionally a metal from Group VIII (IUPAC Groups 8-10), supported on alumina or silica/alumina. In embodiments, the catalyst is sulfided NiMo. In embodiments, the HDO reactor 20 includes a catalyst bed 22A and a catalyst bed 22B wherein the catalyst bed 22A has a lower net active metal content than the catalyst bed 22B.

The HDO reactor operates at a hydrogen partial pressure between 500 and 2500 psia, preferably between 900 and 1900 psia. The LHSV based on volumetric throughput of the lipid feedstock 101 is between 0.3 and 3.0 h⁻¹. The hydrogen to lipid ratio between 4,000 and 18,000 SCF/Bbl, preferably in the 6,000-12,000 SCF/Bbl range.

The HDO reactor 20 also includes a mixing box 23 to redistribute the liquid and gas in the reactor, and to reduce the temperature rise across the reactor by use of a quench hydrogen 104.

At the described HDO conditions, the HDO selectivity is less than 89%. For example, the HDO selectivity is 88%, 87%, 86%, 85%, 84%, 83%, 82%, or an HDO selectivity between any two of these values. For example, the HDO selectivity is between 82% and 89%, between 82% and 88%, between 82% and 87%, or between 82% and 86%.

An HDO reactor effluent 110 is cooled through a feed-effluent exchanger 30 to provide a partially cooled effluent 111 for further cooling in a cooler 32. A cooled HDO reactor effluent 112, having a temperature between 350 and 450 F is processed through an HDO high pressure separator 34. The two-phase (gas/vapor and liquid) reactor effluent 110 is thus separated into a gas/vapor stream 124 and the HDO product 113.

A portion of the HDO product 113 is transferred to a stripping column 50 as stripping column feed 114, while the rest is recycled to the HDO reactor as a recycle solvent 115.

The stripping column feed 114 is stripped of dissolved H₂S, CO, CO₂, NH₃, and H₂O (all gas-phase byproducts of lipid conversion in the HDO reactor) using a stripping gas 121. The stripping gas may be steam, nitrogen, hydrogen, or natural gas. The stripping column 50 may be operated at a pressure between 30 and 1000 psig, at temperatures between 250 F and 450 F.

A stripped HDO product 122 is thus provided for isomerization in the HI reactor 70.

The nitrogen content of the stripped HDO product 122 is less than 0.85 wppm. For example, the nitrogen content is 0.80 wppm, 0.75 wppm, 0.70 wppm, 0.65 wppm, 0.60 wppm, 0.55 wppm, 0.50 wppm, or a nitrogen content between any two of these values. For example, the nitrogen content of the stripped HDO product is between 0.50 wppm and 0.85 wppm. When the lower detection limit of the nitrogen analyzer is 0.50 wppm or higher, the stripped HDO product nitrogen is below detection limit.

The TAN of the stripped HDO product 122 is less than 0.10 mg KOH/g. For example, the TAN is 0.08 mg KOH/g, 0.06 mg KOH/g, 0.04 mg KOH/g, 0.02 mg KOH/g, or a TAN between any two of these values. For example, the stripped HDO product TAN is between 0.02 mg KOH/g and 0.08 mg KOH/g. When the lower detection limit of the titration technique is 0.02 mg KOH/g or higher, the stripped HDO product TAN is below detection limit.

The stripped HDO product 122 has an iso/normal ratio of at least 0.06. For example, the iso/normal ratio is 0.08, 0.10, 0.12, 0.14, 0.16, 0.18, 0.20, or an iso/normal ratio between any two of these values. For example, the stripped HDO product iso/normal ratio is between 0.08 and 0.20.

The stripped HDO product 122 is transferred to the HI reactor 70 using a pump 60. (In embodiments where the stripping tower 50 operates at a higher pressure than the HI reactor 70, the pump 60 is not necessary.) A pressurized HI reactor feed 210 is heated through an HI feed effluent exchanger 62 to provided a partially heated HI feed 212. The partially heated HI feed 212 is combined with a pressurized hydrogen-rich gas 236 to provide a hydrogen containing feed 213 for further heating in an HI preheater 64 to provide a pre-heated HI feed 214.

The HI preheater 64 is operated to raise the HI feed 214 to a temperature between 590 F and 640 F, preferably between 600 F and 630 F. The HI feed 214 is subsequently contacted with a catalyst 72 in the HI reactor 70. The catalyst 72 is a bi-functional catalyst with a support/carrier providing acid functionality, and a Group VIII metal (IUPAC Groups 8-10 of the periodic table) providing hydrogenation-dehydrogenation functionality. The support/carrier may be amorphous or crystalline, and the metal may be a base metal or a noble metal. In embodiments, the catalyst comprises platinum and palladium dispersed on an amorphous silica/alumina support. In embodiments, the catalyst comprises platinum dispersed on a shape selective crystalline support containing a molecular sieve such as ZSM-11, ZSM-22, ZSM-23, ZSM-48, SAPO-11, SAPO-31, SAPO-41, SSZ-16, SSZ-39, MCM-22, zeolite Y, ferrierite, mordenite, ZSM-5 or zeolite beta, with the shape selectivity providing benefits in isomerization of linear hydrocarbons.

In embodiments, the HI reactor operates at a WABT less than 616 F. For example, the WABT is 614 F, 612 F, 610 F, 608 F, 606 F, 604 F, 600 F, or a temperature between any two of these values. For example, the HI reactor WABT is between 600 F and 616 F.

The HI reactor operates at a hydrogen partial pressure between 300 and 1200 psi, LHSV between 0.5 h⁻¹ and 2.0 h⁻¹, and a hydrogen-to-oil ratio between 1,000 and 5,000 SCF/Bbl. In preferred embodiments, the LHSV is between 1.0 and 1.5 and the hydrogen partial pressure is between 500 and 1000 psi.

The HI reactor may contain one bed of the catalyst 72 or a plurality of beds (not shown). The HI reactor effluent 216 is cooled through the HI feed-effluent exchanger 62 to provide a partially cooler HI effluent 218 for further cooling in HI effluent cooler 80. The cooled HI effluent 220 is a two-phase fluid comprising a liquid phase and a gas phase. This is separated in separator drum 82 to provide an HI separator gas stream 231 rich in hydrogen and a liquid hydrocarbon 222 comprising isoparaffins.

The liquid hydrocarbon 222 is fractionated in a first distillation column 84 to remove the mainly C8 and lighter hydrocarbons from the diesel boiling range hydrocarbon stream recovered as a first distillation column bottoms fraction 224. A first distillation column overhead fraction 226 is subsequently processed through a second distillation column 86 to provide a stabilized naphtha 228 with a Reed Vapor Pressure (RVP) between 8 psi and 13 psi, and a propane-rich overhead fraction 230. The propane-rich overhead fraction 230 is at least 90 mol % propane with the balance mainly n-butane and isobutane. In embodiments, the propane-rich overhead fraction 230 is at least 95 mol % propane.

The first distillation column bottoms fraction 224 is a renewable diesel (RD) with a flash point of 52° C. or higher and a cetane number of 80 or higher.

The RD cloud point is preferably greater than or equal to −12° C. For example, the RD cloud point is −11° C., −10° C., −9° C., −8° C., or within the range given by any two of these values. For example, the RD cloud point is between −8° C. and −11° C.

The nC18 (n-octadecane) content of the RD is 6.3 wt % or higher. For example, the nC18 content is 6.4 wt % or higher, 6.6 wt % or higher, 6.8 wt % or higher, 7.0 wt % or higher, 7.2 wt % or higher, 7.4 wt % or higher, 7.6 wt % or higher, 7.8 wt % or higher, 8.0 wt % or higher, 8.2 wt % or higher, 8.4 wt % or higher, or between any two of these values. For example, the nC18 content of the RD is between 6.4 wt % and 8.4 wt %.

The diesel selectivity, as given by the volumetric production of diesel (the first distillation column bottoms fraction 224) as a percent of total liquid fuels produced (the first distillation column bottoms fraction 224 plus the stabilized naphtha product 228) is at least 95.0%. For example, the diesel selectivity is 95.5%, 96.0%, 96.5%, 97.0%, 97.5%, 98.0%, 98.5%, 99.0%, 99.5%, or a diesel selectivity between any two of these values. For example, the diesel selectivity is between 96% and 98%, or between 97% and 99%.

Returning now to the HDO high pressure separator 34, the vapor/gas stream 124 is combined with a wash water stream 125 before cooling in a cooler 40 to provide a three-phase stream 210 containing gas/vapor, hydrocarbon liquid, and water. These are separated in a three-phase separator 42. A water stream 128 and a hydrocarbon liquid stream 128A are thus separated from a gas/vapor stream 129 comprising mainly of hydrogen for recycle. In addition to hydrogen, the gas/vapor stream 129 also contains propane, methane, CO, CO₂, H₂S, and NH₃. In embodiments, the separator 42 functions as a scrubber where an aqueous solvent 127 comprising caustic or an amine (e.g. diethanolamine, monoethanolamine, and methyldiethanolamine) is used to remove CO₂ and H₂S from the recycle hydrogen.

A bleed stream 129A is removed from the recycle H2-rich gas to prevent buildup of gas phase HDO byproducts such as propane, CO, and methane that are not effectively removed by scrubbing. Although not shown in FIG. 1, the bleed gas is preferably directed to a membrane separator (not shown) for separation into a propane-rich retentate (for propane recovery in the second distillation column 86) and a hydrogen-rich retentate (for compression and recycle to the HDO reactor).

A makeup hydrogen 233 is pressurized in a first stage compressor 44A and combined with the HI separator gas 231 to provide a second stage compressor feed 234. A second stage compressor 44B further pressurizes this stream along with HDO recycle gas 232 to provide recycle hydrogen-rich gas streams 130 and 236 for the HDO and HI reactors respectively. In the present embodiments wherein the HDO reactor operates at a higher pressure than the HI reactor, the recycle hydrogen-rich gas stream 130 is further pressurized in a third stage compressor 44C to provide pressurized HDO hydrogen-rich gas 132. This stream provide hydrogen 133 for the recycle solvent and hydrogen 104 for reactor quench.

The hydrogen 133 is combined with the recycle solvent 115 after pressurization in a recycle pump 36, that is a pressurized recycle solvent 126. A two-phase fluid 118 comprising hydrogen and recycle solvent is subsequently partially heated in the feed-effluent exchanger 30 to provide a partially heated solvent 119. The partially heated solvent 119 is further heated in a heater 46 to provide the pressurized hydrogen-containing hot solvent 107.

It will thus be seen according to the present invention a highly advantageous method for manufacture of renewable diesel has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

### Example

Operating parameters of a renewable diesel plant, as described in the specification herein, were analyzed to determine which process variables impacted diesel selectivity. The dataset corresponded to about two years of operating data, with periods immediately prior to and following plant outages identified as outliers and removed. The dataset included HI selectivities in the 94.5% to 97.0% range, HDO selectivities in the 82% to 94% range, RD cloud points in the −8.2 C to −14.5 C range, HI product nC18 values in the 5.7 to 8.5 range, and stripped HDO product nitrogen and TAN values in the 0-1.9 ppm and 0-0.10 mg KOH/g ranges respectively. Four day moving averages were calculated for the HDO product nitrogen and TAN variables to account for the theorized persistent effect on HI selectivity. Stratified sampling was used to split the dataset into training and test subsets while retaining similar distributions of HI selectivity in both. Thirty percent of the original dataset was split out to form the test set, with the remainder forming the training dataset. A multivariate regression model was fit to the dataset and the included variables were evaluated for significance. A few parameters were found to be significant in predicting HI selectivity at a significance level of 0.05. A multivariate regression model was refit to the data, this time only including those variables found to be significant in the first iteration. All the variables included in this model were found to be correlated with HI selectivity at a significance level of 0.001. The significance of variables such as HDO selectivity and nitrogen in particular were surprising. All the included variables are shown in the following correlation between HI selectivity and the process parameters of significance:

$$HI Selectivity = A * ( HDO selectivity ) + B * ( Cloud Point ) + C * ( nitrogen ) + D * ( nC 18 ) + E * ( TAN ) + F * ( WABT ) + G * ( iso / normal ratio )$$

While all the variables in the above equation were found to be significantly correlated with HI selectivity, the absolute value of the t value for each variable can be used as a relative indicator of the confidence each variable's coefficient is non-zero. HDO selectivity had the largest absolute value t-value of all the significant variables, indicating the highest level of confidence in a non-zero coefficient.
The square of the correlation coefficient for the above model is 0.70. The performance of this model was evaluated by applying the model to the test dataset generated earlier and examining the error between predicted and observed HI selectivity in that dataset. The overall error of the model was calculated as residual standard error and found to be 0.24. In the above linear equation, the constants A, C, E, F, and G were negative indicating that the parameters in parentheses next to these constants need to be low to maximize HI selectivity. Conversely, the constants B and D were positive suggesting the other two parameters need to be high to maximize diesel selectivity. By operating within the preferred range, HI selectivity was subsequently raised above the range used in the original dataset.

1. A method for manufacturing renewable diesel comprising the steps of
(a) subjecting a lipid to deoxygenation under hydrodeoxygenation (HDO) conditions to provide a paraffinic HDO product
(b) stripping the paraffinic HDO product with a stripping gas to provide a stripped HDO product
(c) subjecting the stripped HDO product to hydroisomerization to provide a hydroisomerization (HI) reactor effluent
(d) fractionating the HI reactor effluent to provide a renewable diesel (RD) and a naphtha fraction
wherein the HDO selectivity is less than 89% and the diesel selectivity is greater than or equal to 95%.

2. The method of claim 1 wherein the diesel selectivity is between 95.5% and 99.5%.

3. The method of claim 1 wherein the HDO selectivity is between 82% and 89%.

4. The method of claim 1 wherein the RD has a cloud point between −8° C. and −12° C. and a n-octadecane content of 6.3 wt % or higher.

5. The method of claim 1 wherein the naphtha has a Reed Vapor Pressure between 8 psi and 13 psi.

6. The method of claim 1 wherein the stripped HDO product has a Total Acid Number (TAN) less than 0.10 mg KOH/g.

7. The method of claim 1 wherein the stripped HDO product has a nitrogen content less than 0.85 wppm.

8. The method of claim 1 wherein the stripped HDO product has an iso/normal ratio of 0.06 or higher.

9. The method of claim 1 wherein the HI reactor WABT is between 600° F. and 616° F.

10. The method of claim 1 wherein Step (d) comprises a distillation wherein a propane-rich overhead fraction is separated from the naphtha and the propane-rich overhead fraction is at least 90 mol % propane with the balance n-butane and isobutane.

11. The method of claim 1 wherein the HDO conditions occur in the presence of NiMo catalyst.

12. The method of claim 1 wherein the HI reactor includes a bifunctional catalyst comprising platinum.
